(19) United States
(12) Patent Application Publication
(10) Pub. No.: US 2026/0249830 A1
(43) Pub. Date: Aug. 27, 2026

(54) RE-TENSIONABLE MICROPROCESSOR-CONTROLLED PARKING BRAKE LOCK AND MICROPROCESSOR-CONTROLLED PARKING BRAKE LOCKING METHOD

(71) Applicant: AUMOVIO Germany GmbH, Frankfurt am Main (DE)

(72) Inventors: Peter Stauder, Mainz (DE); Jürgen Balz, Huenstetten Oberlibbach (DE); Martin Watzlawik, Maintal (DE)

(73) Assignee: AUMOVIO Germany GmbH, Frankfurt am Main (DE)

(21) Appl. No.: 19/552,697

(22) Filed: Feb. 27, 2026

(30) Foreign Application Priority Data
Feb. 27, 2025 (DE) 10 2025 107 499.2

(51) Int. Cl. B60T 13/74; B60T 8/171

(52) U.S. Cl. CPC B60T 13/748; B60T 8/171

(57) ABSTRACT

An electrically actuatable parking brake for an electrically actuator-driven motor vehicle wheel brake comprises a form-fitting locking element which is translationally displaceable for form-fittingly locking or releasing a brake actuating device to enable re-tensioning. An electric linear actuating device, together with an associated locking element, makes it possible, under the control of a microprocessor, as required, in conjunction with the electric actuator, to perform re-tensioning, without restricting the secure stationary braking of a form-fittingly secured parking brake engagement.

### TECHNICAL FIELD

An electric parking brake with a parking lock, also referred to as a locking mechanism, can be engaged in a form-fitting manner by means of a special parking locking device.

### BACKGROUND

Combined electric motor vehicle wheel brakes of the type EMB (electro-mechanical brake) are caliper brakes or drum brakes and have at least one electrically rotationally arranged service brake actuator, which may be provided as a motor-gear drive train with a rotation-translation converter which, via at least one adjustable piston, cooperates with at least one directly actuated friction lining which can be in friction braking engagement with a rotatably mounted brake rotor (brake disk or brake drum).

In the relevant passenger motor vehicle wheel brake systems, the EMB service brake actuator drive train is basically highly efficient, i.e. designed to be as friction-free as possible and open, i.e. released, when electrically deenergized. In the narrower sense, the parking brake relates to a combined wheel brake, the service brake function of which is defined as normally released, whereas the sought parking brake locking function is reversible and locked when electrically deenergized. The architecture of the intelligent and electronically configured vehicle brake systems comprises one or more electronic control units, which includes sufficient status detection, i.e. knowledge of the current operating status of the parking brake lock (for example a) actuated/re-tensioned or b) unactuated/released or c) defective). It is the intention for the parked motor vehicle system to be able to perform automated re-tensioning without releasing an actuated parking brake lock.

By way of example, in a vehicle state in which the vehicle is basically stationary braked, a re-tensioning process of the parking brake locks may be necessary in order to guarantee the necessary locking effect with sufficient certainty. Basically, it is possible to specify a temporally successive, namely decreasing, brake application effect, as a physical effect of thermal component shrinkage following the application of the motor vehicle wheel brake - locked in a highly heated parking brake state. Influences - for example system-internal action or (external) kinematic excitation on a parked and locked motor vehicle wheel brake/vehicle can act (for example owing to an impact or a vibration excitation during vehicle transport, for example by truck, ship or a conveying device (conveyor belt, elevator), or can give rise to an unsafe situation. As a result of vibration/rotational excitation, a locking engagement in the drive train of the brake actuating device by means of a locking bolt could be impaired. A displaced locking element could be undesirably disengaged or moved backward, resulting in an instantaneous loss of any parking brake action.

For a motor vehicle wheel brake with a parking brake lock which is being engaged (actuated) in a form-fitting manner, in the parked vehicle state, special operating conditions are conceivable, in combination, which can include risks or a loss of brake re-tensioning force, with the consequence that re-tensioning should be offered as a countermeasure in order to avoid safety problems. Additional build-up of application force cannot always be directly applied to a brake actuator drive train that is locked via form-fitting engagement if the parking locking element jams or inhibits the build-up of brake re-tensioning force (criteria are efficiency, comfort, noise and safety). An object is therefore to avoid unnecessary wear and tear of a parking locking element with increased safety and to design the parking brake stationary management without interruption.

DE 10 2011 079 362 B4 elucidates a previously known re-tensioning method for an electromechanical brake having an actuator driven by an electric motor which, in order to implement a parking brake functionality, presses a brake element against a brake body during a force stroke, wherein, for re-tensioning, a number of temporally successive force strokes are exerted, wherein the force strokes are respectively exerted as soon as the tensioning force of the brake has reached a predefined minimum application force setpoint value wherein the respective force stroke is executed such that a predefined maximum tensioning force is not exceeded, wherein an expected total loss of tensioning force is determined on the basis of the starting temperature of the brake body and the expected final temperature of the brake body, and wherein the time of a final force stroke is selected such that the sum of the previous force strokes, the last force stroke and the still expected loss of tensioning force at this time exceeds the expected total loss of tensioning force.

DE 10 2024 204 173 A1 relates to an electric parking brake EPB, which is electrically switchable by a solenoid and guided in translation and arranged rotationally fixed in a receptacle, by means of a defined parking lock element in a translationally displaceable bar form with a pawl which is suitable and intended for the form-fitting radial engagement in a recess of a rotary driven counter-component of the brake actuator drive train of the electric motor vehicle wheel brake. This parking lock is designed to be monostable and released when electrically deenergized, in that the radially displaceable locking element is acted upon directly, i.e. permanently, by a defined elastic preload force in order to therefore be forced fundamentally automatically in the direction of the release position of the parking lock. re-tensioning capability is not described.

DE 199 44 876 A1 (cf. FIG. 1 below) describes an electric motor vehicle brake 1 of the combined disk brake type having a rotationally fixedly mounted brake housing 2 and a brake actuating device 3. The brake housing 2 is mounted, together with the actuating device 3, in a rotationally fixed and axially displaceable manner - in a sliding-caliper disk brake configuration - on a brake holder (not shown) which is fixed with respect to the vehicle. The brake actuating device 3 comprises a rotating electromotive drive 4 and a reduction transmission 5. for a switchable electric parking brake function EPB in accordance with the form-fitting principle, this combined electric sliding-caliper motor vehicle brake integrates a locking element 6 (which is rotationally fixed with respect to the electromotive axis of rotation but is mounted in a pivotable rocker-like manner for switching), which engages in the motor-gear drivetrain (MGU). The electromagnetically switchable rocker serves as a form-fitting parking lock, which is suitable and intended to radially engage, from the outside, in a recess of a counter-component of the drivetrain of the actuating device 3. Thus, in the parking brake function shown, the locking pawl 6 arrests/locks the drive train by means of a form-fitting engagement. A permanent magnet 8 and an electrical coil 9 serve as a switching device 7 for shifting the locking pawl 6. The locking pawl 6 can be equipped with detent means 10 which enable mechanical engagement of the locking pawl 6 in the actuated or unactuated position (FIG. 1). The switching device 7 of the locking pawl 6 is thus defined as an electromechanically constructed "flip-flop" with exactly two defined positions (x) locked and y) released).

### SUMMARY

The object is to increase the safety of known parking locks, for example to provide a parking locking module or an improved electric parking brake with parking lock which avoids loss of the locking effect and reliably reproduces the functionality of a re-tensioning process both on the hardware side and in terms of control technology. It is sought to prevent undesired malfunctions (loss of the locking function) and excessive mechanical wear.

The object is achieved in principle for an electric motor vehicle wheel brake as follows,. An electric brake actuating device cooperates with a locking element which can be radially moved in translational manner into a form-fitting parking brake locking position PBS, or can be moved radially back into a parking brake release position PBL. The locking element may be spring-loaded and cooperates with a electric linear actuating device, which is assigned to said locking element, in order to enable readjustment.

The electric linear actuating device acts as an electrically actuatable, namely relatively displaceable, stop or as a movable bearing socket for a telescopic locking element which can be spring-loaded and is displaceably mounted. The linear actuating device has a quiver-like or pot-shaped housing, which may be represented as a nut which is rotationally fixed and translationally movable. Thus, a nut of a linear actuating device can integrate a movably guided bearing function for a locking (bolt) element. By way of the linear actuating device, the locking pawl can be moved alternately - as required - selectively to the positions PBS and PBL, that is to say it can be retracted to the locking engagement position PBS for parking brake actuation or, for releasing the parking brake, it can be shifted back from a locking engagement position PBS into a released release position PBL. Furthermore, by means of the linear actuating device, a partial braking position PTL can be realized which, for re-tensioning, can be performed without wear in an automated manner under microprocessor control, without leaving vehicle stationary management. Accordingly, by way of example, it is in principle possible to selectively relieve the load on the locking pawl by means of an electric motor, for example with the aid of a microprocessor, by means of the partial braking position PTL while the parking brake function is still active, without leaving the form-fitting engagement, in order to subsequently carry out a planned re-tensioning process before the locking element is subjected to a defined spring preload force for holding it when electrically deenergized.

### BRIEF DESCRIPTION OF THE DRAWINGS

An exemplary embodiment will be explained in more detail by means of the drawing on the basis of the description of the figures. In the drawing, in each case schematically:

FIG. 1 shows a known combined electric motor vehicle wheel brake of the sliding-caliper disk brake type according to DE 199 44 876 A1 with electrically switchable locking element 6 for electric parking brake function, in the form of a swinging rocker in the parking brake locking position PBS, reduced and in longitudinal section,

FIG. 2 shows an enlarged basic diagram of a longitudinal section of the components of interest of an embodiment - only of the parking brake with peripherals omitted - comprising the adjacent translationally arranged motor actuating device for an electromotive pawl actuating device, in section, illustrating the positioning/interaction of the components in a released functional position as a released end position for illustrating an non-actuated release state of the electric parking brake,

FIG. 3 is similar to FIG. 2 but shows the positioning/interaction of the components in a partially electromotive shifted adjustment for illustrating a partially actuated and nevertheless fundamentally secured parking brake state, and wherein the pawl and the drive train are not entirely disengaged, and

FIG. 4 shows a schematic diagram of an embodiment of the parking brake including an automatically motorized pawl actuating device, in section, illustrating the mutual positioning/interaction of the components in the functional position (engagement end position) actuated by the parking brake for illustrating the secured and current-less inhibited re-tensioning state (actuated state) of the electric parking brake.

### DETAILED DESCRIPTION

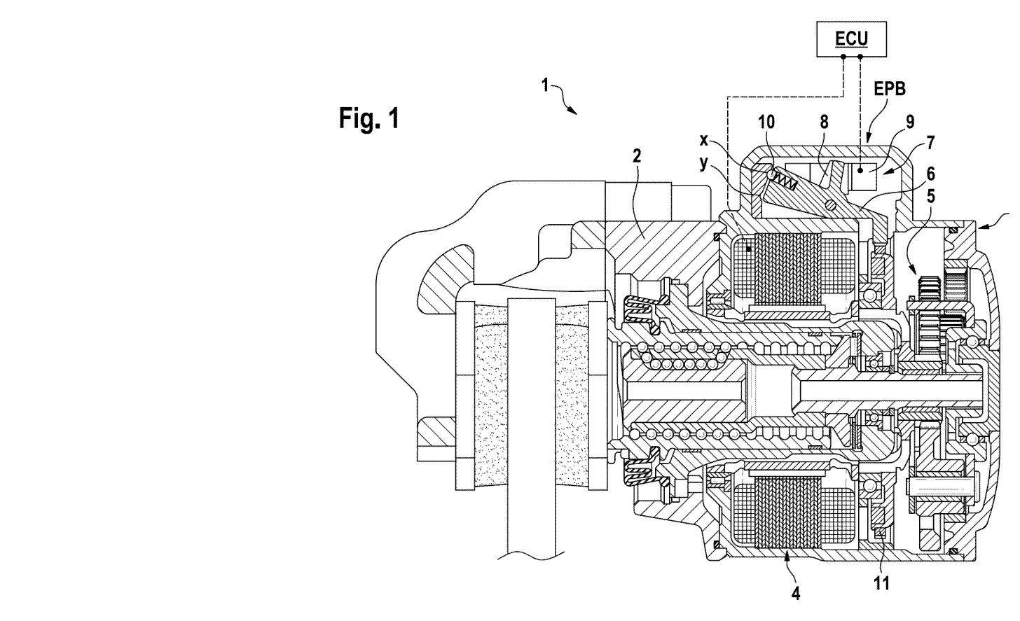

FIG. 1 illustrates an electric motor vehicle brake 1 of the combined disk brake type according to DE 199 44 876 A1 in the actuated (arrested) parking brake position. This disk brake has two friction linings which are arranged on both sides of a brake disk, and wherein, for central brake disk clamping, the re-tensioning force generation is construed with a one-sided and directly actuated friction lining, wherein the opposite friction lining is pressed against as a result of reaction force. Here, the sliding caliper configuration is provided with the rotationally fixed mounted brake housing 2 and with an electric brake actuating device 3 which acts directly on the one friction lining. The brake actuating device 3 is mounted (together with and) via the brake housing 2 in a rotationally fixed manner and in an axially displaceable manner for generating a reaction force on a brake holder, not shown, which is positioned fixedly with the vehicle. The brake actuating device 3 comprises the electric-motor-powered rotary drive 4 and a reduction transmission 5 together with rotation/translation converter. For a switchable electric parking brake function EPB, a locking element 6 is defined in accordance with the form-fitting principle as an electromagnetically switchable rocker for locking the motor-gear drive train (MGU). For this purpose, the locking element 6 engages, as a parking lock, in an form-fitting manner in an associated counter-component 11 of the drivetrain of the actuating device 3. Thus, in this context, when the parking brake function is actuated, the locking element 6 serves the purpose of locking the drive train by means of form-fitting engagement in such a way that the holding of a defined parking brake clamping force is basically ensured by locking. A permanent magnet 8 and an electrical coil 9, which are connected to an electronic control unit ECU, are used as switching device 7 for switching the locking element 6. The locking element 6 is provided with detent means 10 which permit mechanical engagement of the locking element 6 in the actuated or non-actuated position. The switching device 7 of the locking element 6 is consequently defined as a "flip-flop" of electromechanical and bistable construction with two digital end positions (a) locked and b) released).

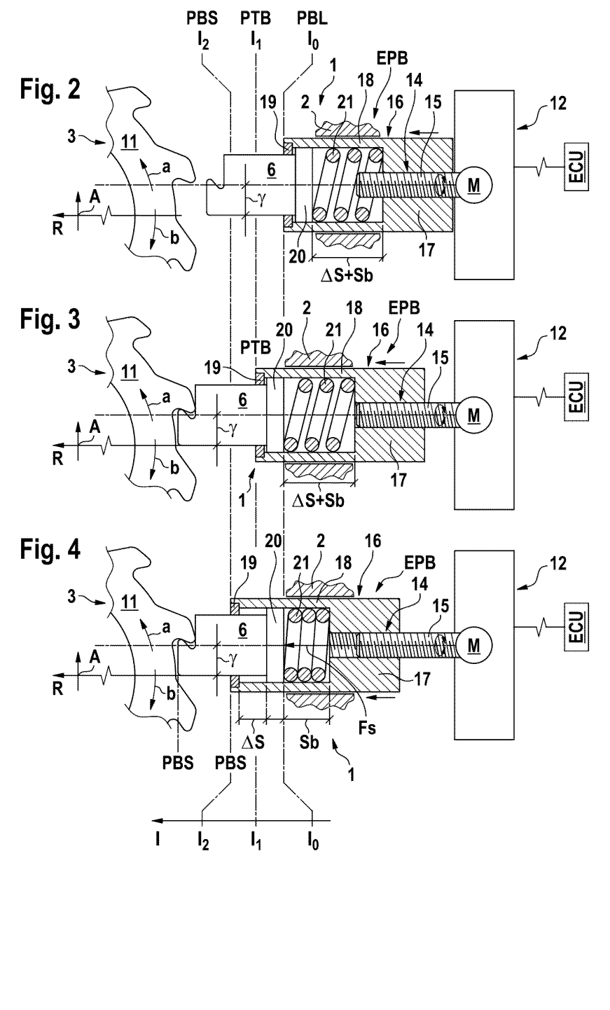

The embodiments will become clear in schematically simplified form from sketches, drivetrain sections, etc., on the basis of the mutually offset positioning shown, as shown in FIGS. 2-4. Here, FIGS. 2-4 illustrate the principle of the embodiments which can in principle be used universally, specifically for example for integration as an electric parking brake EPB in a drivetrain of an electric brake actuating device. In this case, the brake actuating device serves to generate brake re-tensioning force for a parking brake function or service brake function. The linear actuating device is in principle not involved in a brake re-tensioning force generation, but rather serves for form-fittingly (deenergized) holding or releasing of a parking brake function. Accordingly, an actuation method or a motor vehicle wheel brake of the electrically actuatable disk brake type may be provided. Alternatively, the illustrated embodiments is suitable and defined for application as an actuation method or as an electric parking brake EPB in a drive train of an electric brake actuating device for a motor vehicle wheel brake of the electrically actuatable drum brake type. The drawing can be applied universally, i.e. to all conceivable embodiments of motor vehicle wheel brakes.

The mechanical parking brake design is detailed as follows, wherein the description below of the figures describes the most important features, whereas peripherals as well as supplementary features emerge from the drawing partially in model form, in principle, for didactic reasons.

An electrically reversibly actuatable and translationally displaceable linear actuating device 12 serves for translational displacement for a parking brake function on approach or form-fitting engagement of the locking element 6 into the counter-component 11 thereof. For this purpose, the linear actuating device 12 is positioned indirectly or directly on or in a brake housing 2 and has an electric microprocessor-controlled rotary reversible drive, by ECU, using a motor M, the rotatable shaft of which acts indirectly or directly on a rotatably mounted threaded spindle 15 which is defined as axially non-displaceable. The threaded spindle 15, which is mounted rotatably and axially non-displaceably (in relation to the brake housing 2), meshes with a nut 16, which is received in the brake housing 2 and which is non-rotatable but axially relatively displaceable. As a result, the linear actuating device 12 can be moved, by means of the nut-spindle drive, from a parking brake release position PBL (feed position lo, cf. FIG. 2) into a partial parking brake position PTB (feed position l1, cf. FIG. 3) or into the parking brake locking position PBS (feed position l2, cf. FIG. 4). The nut 16 may be of one-piece and cylindrical-pot-like design and is positioned so as to be guided in translationally displaceable but rotationally fixed manner in a longitudinal bore of the brake housing 2. Laterally next to the bottom 17 thereof is a cylindrical, tubular wall 18, which serves as a longitudinal guide for the displaceable locking element 6. A stop 19 for the locking element 6 is formed at a free end of the wall 18. Accordingly, stop 19 limits the relative end positioning of the locking element 6 that is telescopically extended to the maximum from the nut. The stop 19 may be formed in one piece on the wall 18 and may be deformed radially inwardly, such as to be defined, for example, by way of example, in one piece as an edge or collar on the wall 18. In an alternative embodiment, the stop 19 may be present as a separately attached nut component which may be fixed to the wall 18 by one or more fastening means. A connection may be a screw connection between the stop 19 and the wall 18. As a further alternative, the stop 18 could be designed in the manner of a circlip, wherein the circlip can be inserted into a radial groove of the wall 19. The stop 19 can serve as a form-fitting end stop for a socket 20 of the locking element 6. The locking element 6 is thus received, in principle, in a manner which is relative displaceable with respect to the nut 16, and integrated in the nut 16 of the linear actuating device 12 in a telescopically longitudinally guided manner, through the wall 18. At least one spring 21 – for example a helical spring - is integrally received and guided in the nut 16 adjacent to the socket 20. One end of the spring 21 can rest on the bottom 17 in an elastically supported manner, whereas another end of the spring 21 can rest elastically on the socket 20 of the locking element 6. Accordingly, the locking element 6 is mounted and arranged in a guided manner with play ΔS so as to be relatively displaceable in the nut 16 of the actuating device 12. Sb defines a solid length of the spring 21 and, in FIG. 4, Fs defines a spring preload force which, in the parking brake locking position PBS as a result of advance/displacement l2 of the linear actuating device 12, is applied to the socket 20 of the locking element 6 as a closing means for securing parking brake engagement, when play ΔS is consumed. In the sketched partial parking brake position PTB and in the sketched parking brake release position PBL, substantially no spring preload force or at least no significant spring preload force Fs is applied.

As depicted schematically in FIG. 3, the partial parking brake position PTB of the actuating device 12 enables the locking element 6, which is allocated in a relatively displaceable manner - with an elastic spring stop, that is to say telescopically allocated in the nut 16 in quiver-like manner - to perform a more relaxed return movement when the counter-component rotates in the re-tensioning direction. This makes possible a readjustment process which is sufficiently efficient and can also be conveniently metered. An elastic rearward stop or a spring preload force Fs in relation to the locking element 6 is thereby configured to be electrically adjustable, and not structurally fixed as in the prior art. Accordingly, the actuating element 6 is provided with a novel actuating possibility with an increased degree of freedom and with a value-added function.

As a result, the present invention is the first to propose a safe, i.e. secured and also rational re-tensioning process which has no precedent in the prior art. 3 positions with the following function can be identified. In the PBL position (parking brake released), the counter-component 11 of the locking element 6 can rotate freely. Position PTB (partial parking brake position) is used for re-tensioning. Consequently, the engaging locking element 6 can automatically slide (ratchet) on the contour of the counter-component 11, which is actuator-driven in the re-tensioning direction a, and automatically locks against unintentional release in the release direction b. As a result, the re-tensioning process can be carried out safely, efficiently and comfortably (with suppressed ratcheting noise).

An application (i.e. device and also method), may be provided for safe parking of motor vehicles, in electric motor vehicle wheel brakes of a friction brake type (drum brakes and disk brakes are equally conceivable) for an electric parking brake function. The relevant motor vehicles may be passenger motor vehicles, passenger cars or utility vehicles. However, the application possibilities are in principle unrestricted, i.e. in no way restricted to stated primary purposes.

1. A microprocessor-controlled parking brake actuation method comprising:
engaging a translational alternately movable locking element and a counter-component of a brake actuating device on the basis of a parking brake locking position for a parking brake locking function of a motor vehicle wheel brake, or for release on the basis of a parking brake release position; and
defining a displacement of the locking element with a linear actuating device assigned to the locking element, wherein the locking element cooperates in a displaceable manner with the linear actuating device such that, on the basis of a set partial parking brake position, the locking element of the brake actuating device enables re-tensioning without eliminating the parking brake engagement.

2. The microprocessor-controlled parking brake actuation method according to claim 1, further comprising providing the partial parking brake position between the parking brake release position and the parking brake locking position.

3. The microprocessor-controlled parking brake actuation method according to claim 1, wherein the electric linear actuating device is a motor-gear actuating device.

4. The microprocessor-controlled parking brake actuation method according to claim 1, wherein the electric linear actuating device is reversible.

5. The microprocessor-controlled parking brake actuation method according to claim 1, wherein the linear actuating device is telescopic.

6. The microprocessor-controlled parking brake actuation method according to claim 1, wherein the linear actuating device receives or supports the locking element in a relatively displaceable guided manner.

7. The microprocessor-controlled parking brake actuation method according to claim 1, wherein the locking element is mounted on or in a rotationally fixed and translationally displaceable nut of the linear actuating device so as to be relatively displaceable.

8. The microprocessor-controlled parking brake actuation method according to claim 1, wherein the locking element is mounted on or in the linear actuating device by at least one spring.

9. The microprocessor-controlled parking brake actuation method according to claim 1, wherein the linear actuating device has a partial parking brake position, which differs from a parking brake locking position in that a reduced closing action is imparted to the locking element.

10. The microprocessor-controlled parking brake actuation method according to claim 1, wherein the displacement, associated with the linear actuating device in the partial parking brake position includes a relative positioning which is midway between its displacement in the parking brake locking position and its displacement in the parking brake release position.

11. The microprocessor-controlled parking brake actuation method according to claim 1, wherein the linear actuating device has an electronically controllable electric motor with a rotatable rotor to which at least one transmission stage is assigned.

12. The microprocessor-controlled parking brake actuation method according to claim 1, wherein the linear actuating device comprises an electric direct current motor.

13. The microprocessor-controlled parking brake actuation method according to claim 1, wherein at least one of a sensor, an electrical sensor, an electric pushbutton and an electrical switch, is provided for the monitoring, regulation, or positioning of the linear actuating device and/or the locking element.

14. The microprocessor-controlled parking brake actuation method according to claim 1, wherein the electric parking brake, preferably components of the linear actuating device, is designed in modular fashion as a separately handled assembly module with a motor-gear assembly, and in that the assembly module is integrated on or in a brake housing or on or in a brake actuating device of the electric motor vehicle wheel brake.

15. The microprocessor-controlled parking brake actuation method according to claim 1, wherein the linear actuating device has a spindle-nut gear stage.

16. The microprocessor-controlled parking brake actuation method according to claim 1, wherein the spindle-nut gear stage comprises a ball screw.

17. The microprocessor-controlled parking brake actuation method according to claim 1, wherein at least a portion of the parking brake force flow is absorbed through jointly involved parking brake components, downstream in the force flow over a brake housing or downstream in the force flow of a brake holder fixedly mounted on the vehicle.

18. The microprocessor-controlled parking brake actuation method according to claim 1, wherein an electronic control unit defines a re-tensioning controlled in a coordinated manner by a displaceable linear actuating device, wherein the linear actuating device has a displaceable locking element, and wherein the locking element is used for holding with form-fitting engagement or for releasing an associated brake actuating device of an electric motor vehicle wheel brake by, starting from a parking brake-actuated parking brake locking position, moving the electric linear actuating device back into a partial parking brake position such that the locking element can shift back out of its parking brake locking engagement with reduced closing action without a parking brake engagement by the locking element being completely released in order to enable re-tensioning by means of the brake actuating device, and so that, following the re-tensioning, the locking element is shifted back into the parking brake locking position, wherein this can be communicated to the electronic control unit in order to conclude a finished re-tensioning process.

19. The microprocessor-controlled parking brake actuation method according to claim 18, wherein a detected position of at least one of the locking element and the linear actuating device is communicated to an electronic control unit for one of digitized adjusted process control, digitized adjusted system monitoring or digitized adjusted process coordination.
